(19) United States
(12) Patent Application Publication
(10) Pub. No.: US 2007/0112599 A1
(43) Pub. Date: May 17, 2007

(54) Method and system for generating and validating clinical reports with built-in automated measurement and decision support

(76) Inventors: Peiya Liu, East Brunswick, NJ (US); Sridharan Palanivelu, Monmouth Jct., NJ (US); Amit Chakraborty, East Windsor, NJ (US); Dorin Comaniciu, Princeton Junction, NJ (US); Christoph Dickmann, Nurnberg (DE); Sultan Haider, Erlangen (DE); Saikat Mukherjee, North Brunswick, NJ (US); Stefan Scholl, Nurnberg (DE); Jurgen Vaupel, Weisendorf (DE); Volker Wetekam, Marloffstein OT Rathsberg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/585,471

(22) Filed: Oct. 24, 2006

Related U.S. Application Data
(60) Provisional application No. 60/730,414, filed on Oct. 26, 2005.

(51) Int. Cl. G06Q 10/00; G06F 17/00

(52) U.S. Cl. 705/2; 715/513

(57) ABSTRACT

A method and system for generation and validation of clinical reports with built-in automated measurement and decision support is provided. XML templates may be used for ensuring report data quality. The template data may include static, dynamic, calculated data, and others. The validation method may be based on formal logical constraint specifications. The constraint descriptions may include data types, cardinality, order, co-occurrence, Boolean logic, read-only data, regular expression patterns, etc. The method can be used to validate collected data on-the-fly based on constraint specifications without human interaction.

### REFERENCE TO RELATED APPLICATION

The present application claims the benefit of provisional application Ser. No. 60/730,414, filed Oct. 26, 2006, the entire contents of which are herein incorporated by reference.

### BACKGROUND

1. Technical Field

The present disclosure relates to reports and, more specifically, to a method and system for generating and validating clinical reports with built-in automated measurement and decision support data.

2. Description of the Related Art

Reporting is the practice of recording diagnostic results. Traditionally, reporting involved the manual generation of typed or hand-written paper reports. A person engaged in the generation of a report may expend considerable effort to ensure reported data is accurate, valid and complete, however, mistakes are often unavoidable and as a result reports may include data that is inaccurate, invalid and/or incomplete.

Today, reports may be generated with the assistance of computers. Computer-generated reports may then be stored in electronic form and/or printed to paper.

Reports may be generated to capture the diagnostic state of a wide variety of subjects. For example, reports may be used in the practice of medicine to record the medical condition of a patient. Such reports may be called medical reports or clinical reports and may often be found within a patient's medical charts or within a healthcare provider's database.

Reports may also be used in the practice of field service engineering. In field service engineering, field service technicians and/or engineers may travel to the site of an installed machine and perform diagnostic tests, maintenance, and/or repairs on the installed machine.

Reports may also be used in a wide variety of other fields where data may be recorded, stored, and/or reviewed.

In clinical reporting, the healthcare provider, for example a doctor, may perform a series of tests on a patient subject. Tests may include measurement data, for example, blood pressure, body weight, temperature and various test results for laboratory tests performed on samples of patient's blood. This measurement data may be included in the clinical report. Measurement data should be accurately recorded, however, due to such factors as improperly performed tests and data entry errors; measurement data included in clinical reports can often be inaccurate.

Clinical reports may also include professional opinions such as diagnosis and recommended courses for treatment. These professional opinions may be included in the clinical report as well. Professional opinions should be based on correct and accurate data and should be consistent with ordinary standards of care, however, professional opinions included in clinical reports may contain mistakes if, for example, the wrong data was examined or errors of judgement have occurred.

In field service reporting, measurement data and professional opinions may be included in field service reports. Measurement data may include, for example, results of diagnostic programs and performance benchmarks. Professional opinions may include, for example, orders to replace modules that are believed to be problematic. Like clinical reports, field service reports should contain accurate, valid and complete measurement data and professional opinions that are based on correct and complete data and were decided in a manner consistent with ordinary standards of care.

### SUMMARY

A method for generating and validating a clinical report with built-in automated measurement and decision support for collecting report data. Data is collected. Automated measurements and decision support data within one or more template based collection forms is interpreted. One or more logical constraint specifications described by a formal specification language within one or more template based collection forms are interpreted. The collected data is validated as it is collected by comparing the collected data against the interpreted logical constraint specifications. A warning condition is generated when data cannot be validated against the interpreted data constraint rules. Collection of data continues when data is successfully validated against the interpreted data constraint rules. A validated report comprising the collected and validated data is generated based on a template provided within the template based collection forms.

A system for validating a clinical report includes a data collector for receiving data, interpreting automated measurements and decision support data, and interpreting one or more logical constraint specifications described by a formal specification language. A data validator validates the collected data as it is collected by comparing the collected data against the interpreted logical constraint specifications. A template based collection form provides the one or more logical constrain specifications and provides a template for the generated report.

A computer system includes a processor and a program storage device readable by the computer system. The program storage device embodies a program of instructions executable by the processor to perform method steps for validating a report. The method includes collecting data. Automated measurements and decision support data within one or more template based collection forms is interpreted. One or more logical constraint specifications described by a formal specification language within one or more template based collection forms are interpreted. The collected data is validated as it is collected by comparing the collected data against the interpreted logical constraint specifications. A warning condition is generated when data cannot be validated against the interpreted data constraint rules. Collection of data continues when data is successfully validated against the interpreted data constraint rules. A validated report comprising the collected and validated data is generated based on a template provided within the template based collection forms.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 shows an overview of the XML-based template data validation architecture based on logical constraint specifications as applied to clinical reports according to an embodiment of the present invention;

FIG. 2 illustrates key features of template data validations in these logic constraint specifications as applied to clinical reports according to an embodiment of the present invention;

FIG. 3 illustrates the process of progressive data validation for template data collection according to an embodiment of the present invention;

FIG. 4 describes XML Document Type Definition (DTD) for Template Data Constraint Language (TDCL) according to an embodiment of the present invention;

FIG. 5 illustrates a specification example of data range validation by using TDCL according to an embodiment of the present invention;

FIG. 6 illustrates a specification example of co-occurrence data validation by using TDCL according to an embodiment of the present invention;

FIG. 7 illustrates an example for automatic data calculation by using TDCL for automated measurement and decision support data according to an embodiment of the present invention; and

FIG. 8 shows an example of a computer system capable of implementing the method and apparatus according to embodiments of the present invention.

### DETAILED DESCRIPTION

In describing the preferred embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Embodiments of the present disclosure may describe methods and systems for validating reports. The approaches described herein may be applied for reporting in any industry or endeavour, however, for simplicity, embodiments of the present invention are described herein with reference to clinical reporting and field service reporting.

Data may be collected manually or by using a computer. Embodiments of the present invention may be used to validate reports based on data of either origin, however, in the case of manually collected data; the hand-written datasheet may first be computerized, for example, by manual data entry or by optical character recognition. Where data is collected using a computer, data may be entered, for example, by console, using a tablet and stylus, by voice recognition or by direct interface. Examples of direct interface include diagnostic equipment that can automatically enter data into a report.

Applications used to collect data, for example, in the manner described above, may be called data collection applications.

Embodiments of the present invention may integrate report validation into data collection applications to dynamically validate data on-the-fly. Alternatively, embodiments of the present invention may be implemented as standalone applications.

As data may be entered, recording and analysed using a wide variety of devices and applications, a widely accepted standard for describing data may be used. For example, Extensible Markup Language (XML) standards may be used to communicate data from one device or application to another. XML standards may be found, for example, in: XML Extensible Markup Language (XML) 1.0 (Second Edition), W3C Recommendation, 6 Oct. 2000; XML Schema Part 1: Structures, W3C Recommendation, 2 May 2001; XML Schema Part 2: Datatypes, W3C Recommendation, 2 May 2001 and XSL Transformation (XSLT) Version 1.0, W3C Recommendation, 16 Nov. 1999.

By using a common standard for the packaging of data, such as XML, verification of reports may be automated as data may easily be moved from diagnostic device/application and/or data entry device/application to a data analyzing device/application.

Embodiments of the present invention may utilize collected data from reports, for example, data packaged according to XML standards, and perform various analyses on the data to validate the reports. Various techniques and systems of the present invention for the validation of reports may be described below with reference to the figures.

One such approach for the validation of report data is to use XML-based template data validation architecture based on applying a collection of logical tests to the report data. The collection of logical tests may be referred to herein as logical constraint specifications.

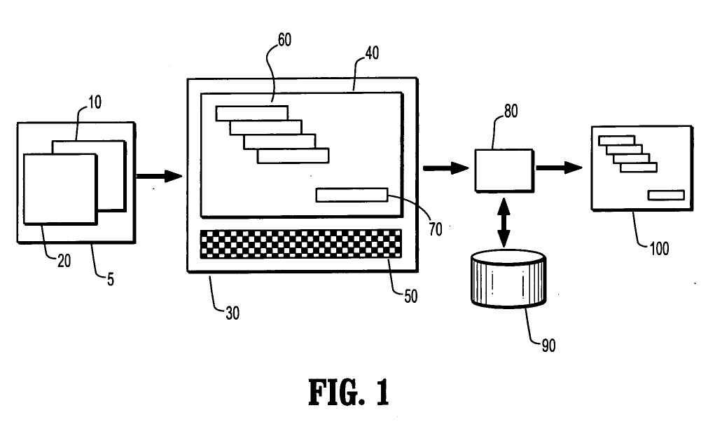

FIG. 1 shows an overview of the XML-based template data validation architecture based on logical constraint specifications as applied to clinical reports according to an embodiment of the present invention. According to this architecture, data may be validated during data collection based on the logical constraint specifications. The logical constraint specifications may be described in a template data constraint language (TDCL), which may be an XML template overlay 5. The XML template overlay 5 may be a template-based data collection form that contains the constraint specifications 10 along with empty form fields 20 that may be used to record received data to form the desired report. The template overlay 5 may include a form document in the PDF file format. The collected and validated data may be filled into the PDF document so that the content and format of the resultant report may be controlled. The constraint specifications 10 may also include automated measurements and decision support data.

The TDCL may specify data constraints in template data collection forms. Examples of data constrains include (a) static data such as data type, data range, etc, (b) dynamic data—co-occurrence data or valued dependent data, (c) calculated data—data are calculated on-the-fly based on other field data or system values such as dates, etc, and (d) pre-populated data, (e) digital signature.

The XML template overlays 5 with constrain specifications and PDF documents may be sent to a data collector 30. Collected data may be received and stored in a database, for example a data collection database 90. The database may be located within the data collection device or within a central server that is accessible by the data collection device. Examples of data collection devices include laptop computers, tablet computers and personal digital assistants (PDAs). The data collector 30 may be network enabled for on-the-fly data synchronization, and/or the data collector 30 may be able to share data at a later point. The data collector 30 may be, for example, an application running on the data collection device.

The data collector 30 may be able to interpret the template data constrain language and thus interpret the logical constraint specifications. The data collector 30 may also be able to implement data collection, for example, by receiving collected data from a user and/or from diagnostic devices. For example, the user may enter data into the data collector 30 via a console 50. The data collector 30 may then be able to perform on-the-fly data validation by testing the collected data against the logical constraint specifications.

The logical constraint specifications 10 represent tests that may fail if the collected data exhibits properties that are unexpected in light of the data that has already been collected or in light of other predefined constrains. For example, in the case of clinical reports, a logical constraint specification may compare observed levels of blood estrogen against the reported gender of the patient subject, if the observed level of blood estrogen indicates that the subject is female and yet the patient's gender has been entered as male the test may fail. For example, in the case of clinical reports, a logical constrain specification may indicate an allowable range of values for a given data field. For example, an allowable range of body temperatures may be within the range of 90 to 110 degrees Fahrenheit and entered values beyond this range may generate a test failure.

The data collector 30 may also be able to generate a warning condition upon identifying a failure of a constraint specification test. The data collector 30 may then be able to display the condition on a screen 40 and/or pass the condition along to a separate display device. Accordingly, the data collector may be able to alert the user (for example, the doctor or field service engineer) immediately upon obtaining an unexpected result. Such an alert may then provide the user with the opportunity to recheck the suspicious data for possible error.

A data validator 80 may be used to perform a progressive data validation process during data collection. The data validator 80 may be invoked by the data collector 30 and thus the data validator 80 may carryout the logical operations of the data collector 30. The data validator 80 and the data collector 30 may both be integrated into a single data collection device.

In this process, the data validator 80 may check if the collected data fall within expected constraints. The check may be performed immediately while entering data. If there is a constraint violation, the data validator may display a warning message according to the constraints specifications.

The data collector 30 may first check if there are any constraints associated with the current data field. If there are no particular constraints for the current field, then the data collector 30 may allow for the normal function for collecting the data. If there are any constraints associated with the current form field, then the data collector 30 may invoke proper operators based on the constraint specification. For example, the data collector 30 may check to see if a supplied patient gender value is either “male” or “female.” If it is not, then a warning message may be displayed.

The data collector 30 may interpret automated measurements from the constraint specifications 10 and use these automated measurements to automatically fill in one or more automated measurement fields 60. Automated measurements may be measurements that are performed automatically and without the assistance of a user. Additionally, automated decision support data from within the constrain specifications 10 may be interpreted. Interpreted automated decision support data may be used to fill in one or more automated decision support fields 70. Automated decision support data may be used to provide formula for checking professional opinions, for example, diagnosis and recommended courses for treatment, against other collected data and/or other constraints to verify if professional opinions appear to be consistent with ordinary standards of care.

Validated reports 100 that are generated using the data validator 80 may be output, for example, in printed form or electronic form.

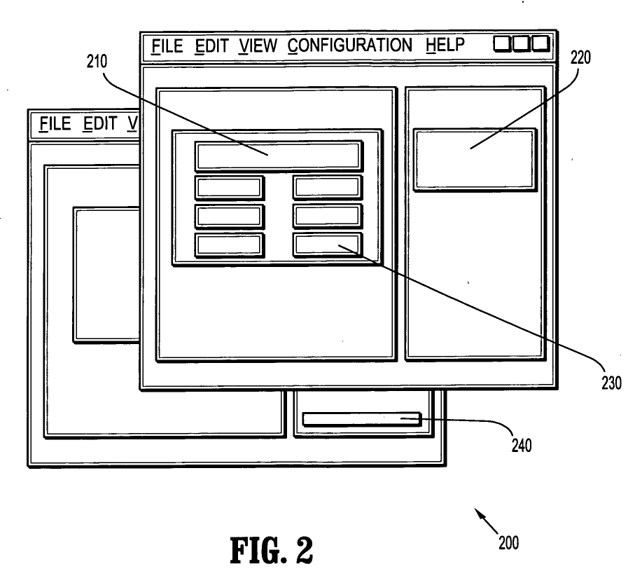

FIG. 2 illustrates key features of template data validations in these logic constraint specifications as applied to clinical reports according to an embodiment of the present invention. One or more communication windows 200 may be presented to the user to show a report as it is being generated and verified. Received data along with calculated data, for example, automated measurement data, may be displayed in various fields 230 of the on-screen report-in-progress 210. The field layout of the on-screen report-in-progress may be provided by the current report template. The current report template may be indicated on-screen, for example, in a report template indicating field 220. Automated decision support data may also be displayed on-screen, for example, in an automated decision support data field 240.

As indicated above, the data specification may be XML-based. Data rules may be enforced on-the-fly and incorporated into the receiving of the data. Data may be pre-populated with expected default values. These default values may be stored within the constraint specifications. A user may then have the ability to modify pre-populated fields as desired. Critical parameters may be protected as read-only so that the values may not be modified by a user. Acceptable value ranges and nominal values may also be interpreted from the constraint specifications. Measurement data and decision support data may be automatically calculated as needed. Integrity checks may be performed to protect the integrity of report data. Before a report may be generated, a completeness check may be performed to ensure that all mandatory fields have been filled. If a mandatory field has not been filled in, the user may be prompted to fill the empty fields before the validated report may be generated. The user may also be prompted to enter a password to authenticate the user and a digital signature may be attached to the report.

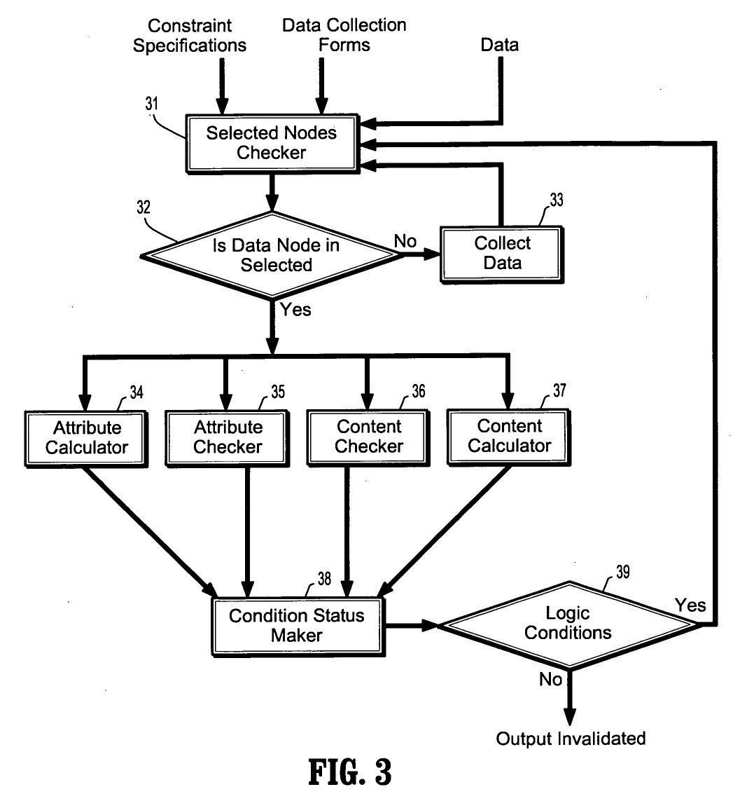

With reference to FIG. 3, the validator may receive constraint specifications, data collection forms and collected data. The data may be checked node by node, with each node representing a particular unit of data. The validator may then initiate a selected node checker to check the validity of the data Step 31. It may first be determined whether the data is in the selected node Step 32. If it is not, then data for the selected node is collected Step 33 and data collection may continue (return to Step 31). If the data is in the selected node, then constraint validation may be performed by the data validator. The process of constraint validation may include four steps: An attribute calculator may automatically calculate if a given value has a particular attribute by using a form field attribute formula supplied by the constraint specification Step 34. An attribute checker may automatically check if a given value has a particular attribute by using a form field attribute supplied by the constraint specification Step 35. A content checker may automatically check if a given value has a particular attribute by using a form field attribute supplied by the constraint specification Step 36. A content calculator may automatically calculate if a given value has a particular content by using a form field content formula supplied by the constraint specification Step 37.

For each checker, a logical variable may be used to hold the value of checking result and a Condition Status Maker may be used to combine the logical values based on the conditions into a single Boolean expression for validation Step 38. The single Boolean expression may then be checked Step 39. If the result Boolean expression is “true” (pass), then Data Collector may continue doing data entering (return to Step 31). Otherwise, it will display the warning messages based on the descriptions in the Condition elements.

Condition status is defined by whether constraint validation was successful or unsuccessful. If the logic condition status is unsuccessful, for example, if validation failed, an appropriate message may be presented to the user. If the logic condition status is successful, for example, if validation passed, the process for collecting and validating data may continue for the next data node.

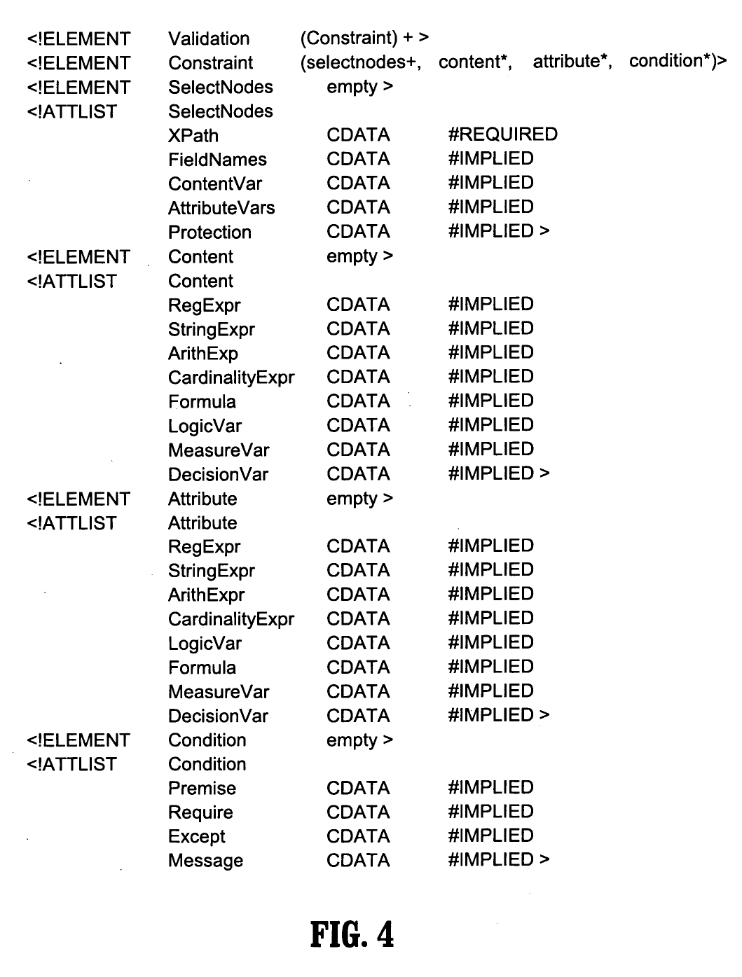

Template Data Constraint Language is a formal specification language used to describe data integrity constraint and calculation. An example of the XML DTD of this language is shown in FIG. 4. The logical constraints specifications may be a sequence of data constraints of content and element attributes in XML for constraining data fields in the template-based collection forms. The root element of the constraint specifications may be called Validation.

Each constraint description may be comprised of four parts: Selectnodes, Content, Attribute, and Condition. Selectnodes may specify the current context variables and fields that are affected by the constraint. Each constraint may comprise one or more selectnodes, for example, where the constraint has a dependency on another value, multiple selectnodes may be used to specify multiple variables and fields. Accordingly, a single constraint may be used to specify dependent or co-occurrence (dependent on constant value) constraints by sharing the variables to express the constraints. Selectnodes may use the following properties: XPath, FieldNames, ContentVar, and AttributeVars in constraint specifications:

1. XPath for describing the context of the selected fields in data collection forms based on the standard XML addressing mechanism Xpath. Xpath, or XML Path Language, is described in Xpath, Version 1.0, W3C Recommendation, 16 Nov. 1999.

2. FieldNames for alternatively describing selected field context by using field name conventions.

3. ContentVar for declaring the content variable of current selected XPath content.

4. AttributeVars for declaring the attribute variables of current selected XPath content. Both content and attribute variables may provide powerful mechanisms for specifying dependent constraints since variables can be shared by the same names to express the dependency.

5. Protection for declaring current protection mode for Selectnodes. The mode can be read-only, rewrite (default mode), and write-once (for digital signature).

The Content and Attribute elements may be used to express the logical constraints under the context of current selectnodes. Both Content and Attribute elements may have the following properties to specify the combination of desired constraints:

1. StringExp may be used for specifying the string type of constraints in the syntax “X##OP##Y” for string comparison. OP is a comparison operators: EQ (equal), LE (less than or equal to), LT (less than), GT (greater than), GE (greater than or equal to), and IN (string inside). X and Y are the values being compared.

2. TypeExp may be used for describing the data type constraints of fields.

3. CardinalExp may be used for the assertion of number of nodes under the current context.

4. ArithExp may be used for declaring the attribute variables for current selected XPath content. Both content and attribute variables provide powerful mechanisms for specifying dependent constraints.

5. Formula may be used for declaring the attribute variables for current selected XPath content. Both content and attribute variables may provide powerful mechanisms for specifying automatic calculation fields.

6. LogicVar may be used for declaring the logical variable name for each content or attribute constraint element.

7. MeasureVar may be used for declaring the automated measurement variable name for each content or attribute constraint element.

8. DecisionVar may be used for declaring the automated decision support variable name for each content or attribute constraint element.

Condition may be used to specify a Boolean expression of logical variables. There could be multiple conditions inside one constraint element. The Condition element may comprise three properties: Premise for logical premise, Require for logical “and”, and Except for logical “not”. The multiple conditions may be used to represent a logical “or.” In this construct, any Boolean formula may be represented. For example, in the following two condition elements:

<Condition Premise= “Z” Require = “X Y” Except=“D Y” />
<Condition Require = “A” Except =“B” />

These conditional elements may denote the Boolean expression:
(˜Z or ((X and Y) and (˜D and ˜Y))) or (A and ˜B).

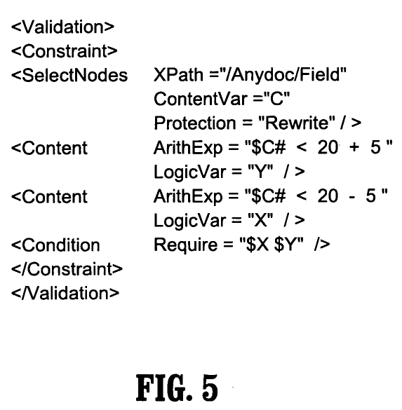

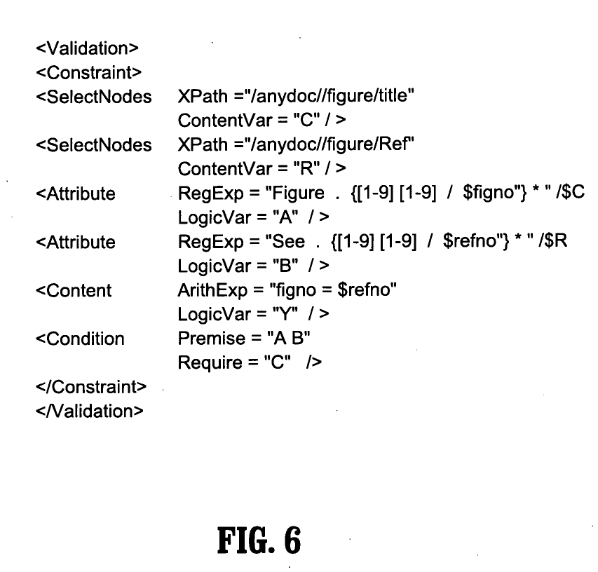

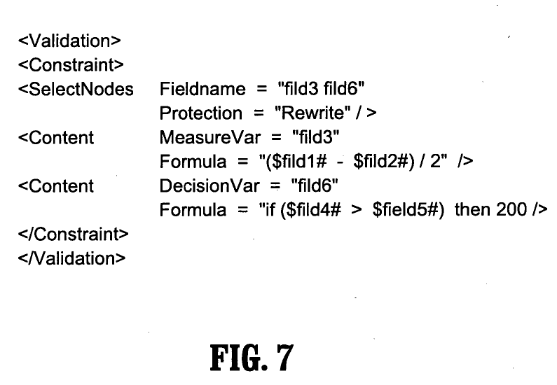

Examples are shown in FIGS. 5, 6 and 7 to illustrate various examples of template data constraint specifications. FIG. 5 illustrates a specification example for data range validation by using TDCL. In this example, the value of Field (denotes by $c) is less than 25 and larger than 15. FIG. 6 illustrates a specification example for co-occurrence data validation by using TDCL. FIG. 7 illustrates a specification example for automatic data calculation by using TDCL. The value of “field3” is automatically calculated based on values of “field1” and “field2.” It is the average of the difference between “field1” and “field2.” The value of “field6” may be calculated by using the values of “field4” and “field5,” for example, in a decision support procedure, “if (field4>field5) then 200.”

Data that is found to violate one or more constraints may give rise to a warning as described above. Following a warning, the user may be permitted to reenter data or use the entered data in spite of the warning. The ability to ignore the warning may be granted to acknowledge the fact that sometimes data may be valid even where it is unexpected. Alternatively, unexpected data may be blocked. There may be instances in which certain data values may be allowable in spite of a warning while other data values are not. The constraint specification may include information necessary to make this determination.

The text of the warning message may be specified in the constraint specification. There may be multiple warning messages and the specific message used may depend on the nature of the failure condition. The warning message may provide the user the opportunity to enter new data or to use the entered data. The warning message may even provide the user with the acceptable range of values.

Data that has been collected and validated may be used to fill in one or more forms that may comprise the validated report. The layout of the forms may be defined, for example, by the PDF layer that is included in the XML template overlays. The validated reports may contain such information as the validated data fields, calculated fields, fields that are automatically filled out, such as, for example, date and time stamp information, and one or more protection fields containing a digital signature.

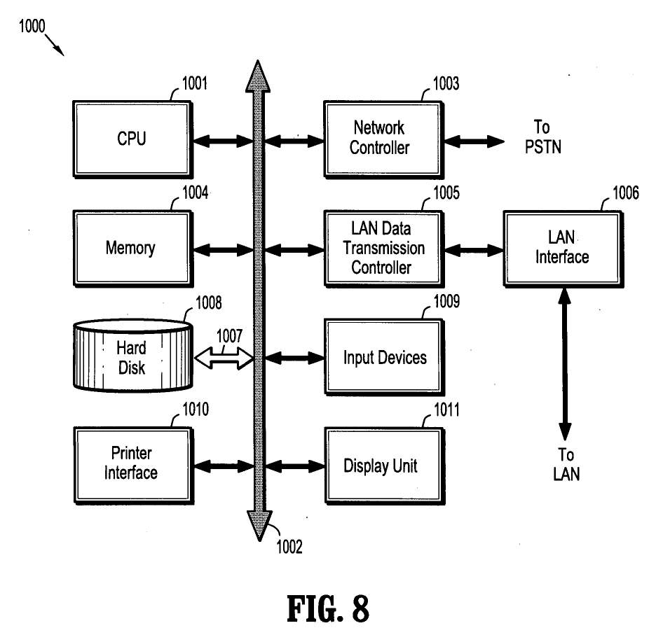

FIG. 8 shows an example of a computer system which may implement the method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

The above specific embodiments are illustrative, and many variations can be introduced on these embodiments without departing from the spirit of the disclosure or from the scope of the appended claims. For example, elements and/or features of different illustrative embodiments may be combined with each other and/or substituted for each other within the scope of this disclosure and appended claims.

What is claimed is:

1. A method for generating and validating a clinical report, comprising:
collecting data;
interpreting automated measurements and decision support data within one or more template based collection forms;
interpreting one or more logical constraint specifications described by a formal specification language within the one or more template based collection forms;
validating the collected data as it is collected by comparing the collected data against the interpreted logical constraint specifications;
generating a warning condition when data cannot be validated against the interpreted data constraint rules;
continuing to collect data when data is successfully validated against the interpreted data constraint rules; and
generating a validated report comprising the collected and validated data based on a template provided within the template based collection forms.

2. The method of claim 1, wherein the template based collection forms comprise:
a PDF file base layer comprising a template for generating a validated clinical report; and
an overlay for specifying the logical constraint specifications on form fields.

3. The method of claim 1, wherein the collected data is defined in XML syntax.

4. The method of claim 1, wherein the formal specification language for describing the logical constraint specifications is Template Data Constraint Language (TDCL).

5. The method of claim 1, wherein each of the logical constraint specifications is described in terms of:
selectnodes for specifying affected context variables and fields;
content for expressing logical constraints under the context of current selectnodes;
attributes for expressing logical constraints under the context of current selectnodes; and
condition for specify a Boolean expression of logical variables.

6. The method of claim 5, wherein the selectnodes comprise the following properties:
Xpath for describing the context of the selected fields in data collection forms based on the standard XML addressing mechanism;
FieldNames for alternatively describing selected field context by using field name conventions;
ContentVar for declaring a content variable of current selected XPath content;
AttributeVars for declaring attribute variables of current selected XPath content; and
Protection for declaring current protection mode for selectnodes.

7. The method of claim 5 wherein the content and attribute elements comprise the following properties to specify the combination of desired constraints:
StringExp for specifying a string type;
TypeExp for describing a data type;
CardinalExp for declaring a content variable for current selected XPath content;
ArithExp for declaring attribute variables for current selected XPath content;
Formula for declaring attribute variables for automated calculation formula of current selected XPath content;
MeasureVar for declaring an automated measurement variable name for each Content or Attribute constraint element;
DecisionVar for declaring an automated decision support variable name for each Content or Attribute constraint element; and
LogicVar for declaring a logical variable name for each Content or Attribute constraint element.

8. The method of claim 5, wherein the condition for specify a Boolean expression of logical variables comprises the following properties:
premise for expressing a logical premise;
require for expressing a logical “and”; and
except for expressing a logical “not”.

9. A system for generating and validating a clinical report, comprising:
a data collector for receiving data, interpreting automated measurements and decision support data, and interpreting one or more logical constraint specifications described by a formal specification language;
a data validator for validating the collected data as it is collected by comparing the collected data against the interpreted logical constraint specifications; and
template based collection forms for providing the one or more logical constrain specifications and for providing a template for the generated report.

10. The system of claim 9, wherein the template based collection forms comprise:
a PDF file base layer comprising a template for generating a validated clinical report; and
an overlay for specifying the logical constraint specifications on form fields.

11. The system of claim 9, wherein the collected data is defined in XML syntax.

12. The system of claim 9, wherein the formal specification language for describing the logical constraint specifications is Template Data Constraint Language (TDCL).

13. The system of claim 9, wherein each of the logical constraint specifications is described in terms of:
selectnodes for specifying affected context variables and fields;
content for expressing logical constraints under the context of current selectnodes;
attributes for expressing logical constraints under the context of current selectnodes; and
condition for specify a Boolean expression of logical variables.

14. The system of claim 13, wherein the selectnodes comprise the following properties:
Xpath for describing a context of the selected fields in data collection forms based on the standard XML addressing mechanism;
FieldNames for alternatively describing selected field context by using field name conventions;
ContentVar for declaring a content variable of current selected XPath content;
AttributeVars for declaring attribute variables of current selected XPath content; and
Protection for declaring current protection mode for selectnodes.

15. The system of claim 13, wherein the content and attribute elements comprise the following properties to specify the combination of desired constraints:
StringExp for specifying a string type;
TypeExp for describing a data type;
CardinalExp for declaring a content variable for current selected XPath content;
ArithExp for declaring attribute variables for current selected XPath content;
Formula for declaring attribute variables for automated calculation formula of current selected XPath content;
MeasureVar for declaring an automated measurement variable name for each Content or Attribute constraint element;
DecisionVar for declaring an automated decision support variable name for each Content or Attribute constraint element; and
LogicVar for declaring a logical variable name for each Content or Attribute constraint element.

16. The system of claim 13, wherein the condition for specify a Boolean expression of logical variables comprises the following properties:
premise for expressing a logical premise;
require for expressing a logical “and”; and
except for expressing a logical “not”.

17. A computer system comprising:
a processor; and
a program storage device readable by the computer system, embodying a program of instructions executable by the processor to perform method steps for generating and validating a clinical report, the method comprising:
collecting data;
interpreting automated measurements and decision support data within one or more template based collection forms;
interpreting one or more logical constraint specifications described by a formal specification language within the one or more template based collection forms;
validating the collected data as it is collected by comparing the collected data against the interpreted logical constraint specifications;
generating a warning condition when data cannot be validated against the interpreted data constraint rules;
continuing to collect data when data is successfully validated against the interpreted data constraint rules; and
generating a validated report comprising the collected and validated data based on a template provided within the template based collection forms.

18. The computer system of claim 17, wherein the template based collection forms comprise:
a PDF file base layer comprising a template for generating a validated report; and
an overlay for specifying the logical constraint specifications on form fields.

19. The computer system of claim 17, wherein the collected data is defined in XML syntax.

20. The computer system of claim 17, wherein the formal specification language for describing the logical constraint specifications is Template Data Constraint Language (TDCL).

21. The computer system of claim 17, wherein each of the logical constraint specifications is described in terms of:
selectnodes for specifying affected context variables and fields;
content for expressing logical constraints under the context of current selectnodes;
attributes for expressing logical constraints under the context of current selectnodes; and
condition for specify a Boolean expression of logical variables.

22. The computer system of claim 21, wherein the selectnodes comprise the following properties:
Xpath for describing a context of the selected fields in data collection forms based on the standard XML addressing mechanism;
FieldNames for alternatively describing selected field context by using field name conventions;
ContentVar for declaring a content variable of current selected XPath content;
AttributeVars for declaring attribute variables of current selected XPath content; and
Protection for declaring a current protection mode for selectnodes.

23. The computer system of claim 21, wherein the content and attribute elements comprise the following properties to specify the combination of desired constraints:
StringExp for specifying a string type;
TypeExp for describing a data type;
CardinalExp for declaring a content variable for current selected XPath content;
ArithExp for declaring attribute variables for current selected XPath content;
Formula for declaring attribute variables for automated calculation formula of current selected XPath content;
MeasureVar for declaring an automated measurement variable name for each Content or Attribute constraint element;
DecisionVar for declaring an automated decision support variable name for each Content or Attribute constraint element; and
LogicVar for declaring a logical variable name for each Content or Attribute constraint element.

24. The computer system of claim 21, wherein the condition for specify a Boolean expression of logical variables comprises the following properties:
premise for expressing a logical premise;
require for expressing a logical “and”; and
except for expressing a logical “not”.
